(19) United States
(12) Patent Application Publication
(10) Pub. No.: US 2026/0087327 A1
(43) Pub. Date: Mar. 26, 2026

(54) FINE-TUNING GENERATIVE NEURAL NETWORKS TO IMPROVE FEW-SHOT PERFORMANCE

(71) Applicant: Google LLC, Mountain View, CA (US)

(72) Inventors: Arjun Reddy Akula, Sunnyvale, CA (US); Kazuma Hashimoto, Menlo Park, CA (US); Krishna P. Srinivasan, Union City, CA (US); Aditi Swanand Chaudhary, Mountain View, CA (US); Karthik Raman, San Jose, CA (US); Michael Bendersky, Cupertino, CA (US)

(21) Appl. No.: 19/339,129

(22) Filed: Sep. 24, 2025

Related U.S. Application Data
(60) Provisional application No. 63/698,554, filed on Sep. 24, 2024.

(51) Int. Cl. G06N 3/0475; G06N 3/045; G06N 3/088; G06N 3/09

(52) U.S. Cl. CPC G06N 3/0475; G06N 3/045; G06N 3/088; G06N 3/09

(57) ABSTRACT

Systems and methods for training a generative neural network, e.g., a large language model (LLM) neural network. The generative neural network is trained on training examples that each include (i) a training input that includes a training query for a corresponding task and a subset of demonstration examples for the task that are most similar to the training query and (ii) the ground truth output for the training query for the task.

### CROSS-REFERENCE TO RELATED APPLICATION

This application claims priority to U.S. Provisional Application No. 63/698,554, filed on Sep. 24, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains a generative neural network, e.g., a language model neural network, e.g., a large language model neural network (LLM), that performs tasks by processing “few-shot” inputs, i.e., inputs that include demonstration examples in addition to a query for the task. Each demonstration example for a particular task includes a respective example query for the task and an example output for the example query.

The subject matter described in this specification can be implemented in particular embodiments so as to realize one or more of the following advantages.

Instruction tuning has emerged as a powerful technique for adapting generative neural networks, e.g., large language models (LLMs), to the diverse tasks that users require, despite their original pre-training for next-token prediction. This process involves further training LLMs on specially crafted datasets where models learn to associate specific instructions with corresponding responses. This method effectively simulates human-like understanding and task execution. Instruction tuning offers significant advantages: it tailors model outputs to specific goals or domain knowledge, allows for human-guided adjustments to model behavior, and provides a computationally efficient way to adapt LLMs to new contexts without extensive retraining.

However, current instruction tuning approaches typically rely on datasets limited to zero-shot, one-shot, or few-shot learning scenarios, with randomly selected in-context examples. This leads to suboptimal use of in-context information, as models trained in this manner often struggle to consistently and effectively leverage the examples provided during inference. For example, this may occur because training with random examples may cause models to become selective, potentially overlooking valuable information even when it is directly relevant during inference. As a consequence, existing models experience a decline in performance as the number of shots increases from 1, 3, 5, and progressively up to 2000, highlighting the model's growing inability to effectively utilize in-context exemplars.

This specification describes a framework that addresses these challenges by enhancing the few-shot and many-shot capabilities of an instruction-tuned generative neural network. In particular, the described techniques achieve this by integrating intelligent strategies for selecting in-context examples directly into the instruction tuning process, thereby encouraging the model to learn from a broader and more informative set of examples. In particular, rather than select demonstration examples at random during training, the describes techniques instead select the examples based on similarities with the query in the training example.

This approach results in highly optimized trained neural networks that consistently utilize in-context information at inference. Experiments show that models trained using the described techniques consistently outperform existing baseline models, achieving substantial gains compared to the baseline models across a variety of tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network training system.

FIG. 2 is a flow diagram of an example process for training the generative neural network.

FIG. 3 is a flow diagram of an example process for determining a measure of similarity between an example query and a training query.

FIG. 4 is a flow diagram of an example process for determining a measure of similarity between a demonstration example and a training query.

FIG. 5 is a flow diagram of an example process for processing a new query after training.

FIG. 6 shows the performance of the described techniques.

Like reference numbers and designations in the various drawings indicate like elements.

### DETAILED DESCRIPTION

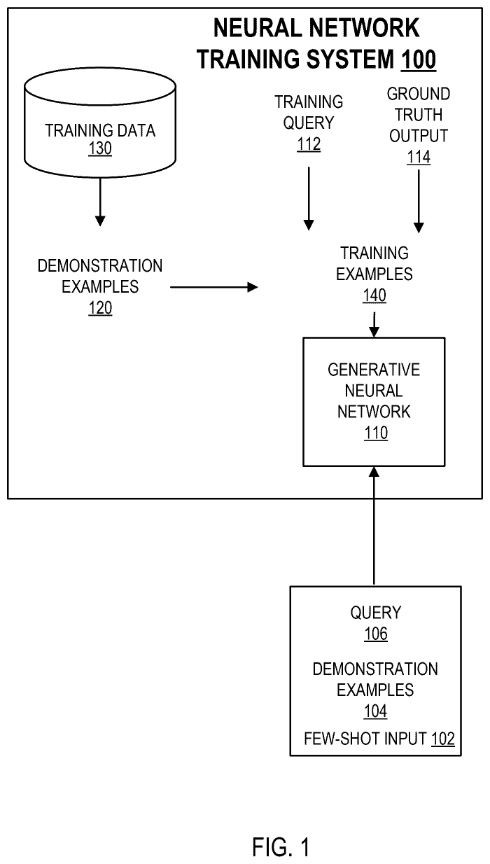

FIG. 1 shows an example neural network training system 100. The neural network training system 100 is an example of a system implemented as computer programs on one or more computers in one or more locations in which the systems, components, and techniques described below are implemented.

The training system 100 trains a generative neural network 110, e.g., a language model neural network, e.g., a large language model neural network (LLM), that performs tasks by processing “few-shot” inputs 102, i.e., inputs that include demonstration examples 104 in addition to a query 106 for the task. Each demonstration example 104 for a particular task includes a respective example query for the task and an example output for the example query.

Including the demonstration examples 104 can provide the generative neural network 110 with information about how to perform the particular task and can improve the performance of the generative neural network 110 on the particular task without further training of the generative neural network 110, e.g., through “in context learning.”

More specifically, the system 100 trains the generative neural network 110 to improve the performance of the generative neural network in processing few-shot inputs 102 after training.

The training performed by the system 100 is generally referred to as “fine-tuning” because, prior to being trained by the system 100, the generative neural network 110 has already been pre-trained on one or more data sets. For example, the one or more pre-training data sets can include one or more unsupervised data sets, one or more supervised fine-tuning data sets, or both.

For example, the one or more previous training stages can include a pre-training stage. During the pre-training stage, the generative neural network 110 can have been trained by the system 100 or a separate system on a next token prediction task, e.g., a task that requires predicting, given a current sequence of tokens, the next token that follows the current sequence in the training data.

As a particular example, the generative neural network 110 can have been trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

As another example, the one or more previous training stages can include one or more additional training stages, e.g., that occur after the pre-training stage. For example, the one or more previous training stages can include any one or more of: a supervised fine-tuning stage, a reinforcement learning stage, a preference learning stage, an instruction tuning stage, and so on.

To perform the training, the system 100 obtains training data 130 that includes a respective set of demonstration examples 120 for each of a plurality of tasks.

As described above, for each task, each demonstration example 120 in the set of examples 120 for the task includes a respective example query and a respective example output for the respective example query.

The system 100 then uses the demonstration examples 120 to generate respective training examples 140 for each of the tasks.

Each training example 140 includes (i) a training input that includes a training query for a task and a subset of the demonstration examples for the task and (ii) a ground truth output for the training query for the task.

In particular, to generate a given training example 104 for a given task, the system 100 obtains a training query 112 for the task and a ground truth output 114 for the training query 112 for the task, e.g., selected from the demonstration examples in the training data 130 for the task or selected from a different set of training data.

The system 100 determines, from the respective set of demonstration examples 120 for the task, a subset of demonstration examples 120 that are most similar to the training query 112.

The system then generates a training example 140 that includes (i) a training input that includes the training query 112 for the task and the subset of demonstration examples 120 that are most similar to the training query 112 and (ii) the ground truth output 114 for the training query 112 for the task.

Thus, rather than randomly selecting the subset of demonstration examples to be included in the training input, the system 100 instead selects the subset of demonstration examples based on similarity, e.g., semantic similarity, with the training query.

The system 100 then trains the generative neural network 110 on training data that includes the training examples 140 for the plurality of tasks.

While the above describes how to generate one training example 140 for a given task, in practice the system 100 generates many different training examples 140 for each of the tasks to be included in the training data by performing the above steps for many different training queries for each of the tasks.

A “similarity measure” as used in this specification can be any appropriate measure that measures the similarity between two embeddings, e.g., cosine similarity, cosine distance, or Euclidean distance.

The generative neural network 110 can be any appropriate neural network that receives as input a sequence of tokens and processes the sequence of tokens to generate an output sequence of tokens. A ‘token’ is data that represents a unit of data, e.g., a text symbol or data of another modality, e.g., a portion of an image, audio signal, or video signal. For example, a ‘token’ can be a one-hot vector or a dense embedding.

In some cases, the generative neural network is a language model neural network that processes tokens representing text symbols or a multi-modal language model neural network that can process tokens representing text symbols and tokens representing data of one or more other modalities, e.g., image, video, audio, and so on. As a particular example of this, the generative neural network can be an auto-regressive neural network that generates the tokens in the output sequence auto-regressively, i.e., one after another. One example of such a neural network is a decoder-only Transformer neural network.

In some situations, the neural network 110 can be referred to as an auto-regressive neural network, i.e., because the neural network auto-regressively generates an output sequence of tokens. More specifically, the auto-regressively generated output sequence is created by generating each particular token in the output sequence conditioned on a current input sequence that includes at least some of the tokens that precede the particular token in the output sequence, i.e., the tokens that have already been generated for any previous positions in the output sequence that precede the particular position of the particular token. In some cases, the current input sequence also includes one or more tokens representing a conditioning or context input for the output sequence.

For example, the neural network 110 can be an auto-regressive attention neural network that includes (i) a plurality of attention blocks that each apply a self-attention operation (e.g., a sequence of attention blocks in which the first attention block of the sequence applies an attention mechanism to an input that includes an “input embedding” of an input token, and each attention block, except the first layer block of the sequence, applies an attention mechanism to a corresponding input which comprises an output of the preceding attention block of the sequence) and (ii) an output subnetwork that processes an output of the last attention block to generate the score distribution, e.g., a score distribution used for selecting an output token, e.g., by sampling from the score distribution or selecting a most likely token according to the score distribution.

In this example, the neural network can have any of a variety of Transformer-based neural network architectures. Examples of such Transformer-based neural network architectures include those described in PaLM: Scaling Language Modeling with Pathways, arXiv preprint arXiv:2204.02311; Rohan Anil, et al., Palm 2 technical report. arXiv preprint arXiv:2305.10403, 2023; the Gemini Team, Gemini: a family of highly capable multimodal models. arXiv preprint arXiv:2312.11805 (2023); Gemini Team, et al., Gemini 1.5: Unlocking multimodal understanding across millions of tokens of context. arXiv preprint arXiv:2403.05530 (2024); and Comanici, Gheorghe, et al., Gemini 2.5: Pushing the frontier with advanced reasoning, multimodality, long context, and next generation agentic capabilities. arXiv preprint arXiv:2507.06261 (2025).

For example, the neural network can include a plurality of layer blocks.

A layer block, as used in this specification, is a collection of one or more neural network layers.

In the example of FIG. 1, the plurality of layer blocks includes one or more attention layer blocks.

During training (and during inference when inference is not auto-regressive), the neural network 110 receives an input sequence that includes a respective input token at each of a plurality of input positions.

The neural network 110 processes the input sequence to generate a network output. During auto-regressive sequence generation after training, the system 100 auto-regressively generates an output sequence that includes a respective output token at each of a plurality of output positions.

To do this, for each output position (after the very first output position in the sequence), the system 100 receives a preceding output token (“new input token”, which is an input token having the current position in the input sequence) generated for the preceding output position and processes the preceding output token using the neural network to generate a network output 112 that specifies the output token at the output position.

During this processing, a given layer block receives an embedding for the new input token and generates as output an output embedding for the new input token, i.e., processes the embedding for the new input token to update the embedding for the new input token.

An embedding of a given input is an ordered collection of numerical values, e.g., a vector of floating point or other numerical values.

When the layer block is an attention layer block, the layer block updates the embeddings by, at least in part, applying an attention mechanism.

Generally, each attention mechanism uses one or more attention heads.

Each attention head generates a set of queries, a set of keys, and a set of values (for example, as the respective products of the input to the attention head with a query matrix, a key matrix and a value matrix associated with the attention head), and then applies any of a variety of variants of query-key-value (QKV) attention, e.g., a dot product attention function or a scaled dot product attention function, using the queries, keys, and values to generate an output. Each query, key, value can be a vector that includes one or more vector elements. “Self-attention” means that the queries, keys and values are derived from the same input sequence.

When there are multiple attention heads, the attention sub-layer then combines the outputs of the multiple attention heads, e.g., by concatenating the outputs and, optionally, processing the concatenated outputs through a linear layer. The attention mechanisms can be local or global (or some attention mechanisms can be local while others for other layer blocks are global). For local attention mechanisms, for each position, the positions (in the input to the attention mechanism) that are used to generate the queries, keys, and values for the position are defined by a local window size for the local attention mechanism, i.e., non-zero attention weights for a given position are computed only for positions that are within the local window of the given position, where the local window is composed of all the input positions which are no more than the local window size before the current input position.

In some cases, because the attention applied by the attention layers is causal, the system 100 can store, in memory and for any given attention mechanism and when generating the output for any given input position, the embeddings or the keys and values already computed for earlier input positions (i.e., for the “context” tokens that precede the current token in the sequence) rather than re-computing the embeddings (or the keys and values) for earlier time steps. Storing the keys and values in a memory is also referred to as maintaining a KV cache.

Some or all of the layer blocks in the neural network can also include other types of sub-layers, e.g., normalization layers, residual connection layers, feedforward sub-layers, and so on.

In some cases, some or all of the feedforward sub-layers within the layer blocks in the neural network are implemented as sparse mixture of experts (MoE) layers while in other cases all the feedforward layers are dense multi-layer perceptrons (MLPs).

The tasks performed after training and the plurality of tasks used for the training can each be any appropriate machine learning task. Some examples of tasks now follow. For example, the machine learning task can be a text processing task.

A “text processing” task is any task that requires processing an input that includes a sequence of text, i.e., a sequence of text tokens, generating an output that includes a sequence of text tokens, or both.

The text tokens can be tokens selected from a vocabulary of text tokens that includes, e.g., one or more of characters, word pieces, words, punctuation marks, numerical symbols, or any other text symbols.

For example, the text processing task can be a text rewriting task that requires processing an input text sequence to generate an output text sequence that is a rewritten version of the input text sequence.

For example, one text rewriting task can be to generate an output text sequence that is a more formal version of the input text sequence but that conveys the same semantic meaning.

As another example, one text rewriting task can be to generate an output text sequence that is a shorter version of the input text sequence but that conveys the same semantic meaning. As another example, one text rewriting task can be to generate an output text sequence that is a more elaborate version of the input text sequence but that conveys the same semantic meaning.

As another example, one text rewriting task can be to generate an output text sequence that a paraphrased version of the input text sequence, i.e., one that uses different words from the input text sequence but that conveys the same semantic meaning.

As another example, one text rewriting task can be to generate an output text sequence that is a proofread version of the input text sequence, i.e., one that corrects grammar and spelling mistakes in the input text sequence.

As another example, the text processing task can be a task that requires generating an output text sequence that is a completion of an input text sequence.

As another example, the text processing tasks can include a task that requires generating an output text sequence that is an answer to or a response to a query posed by the input text sequence. For example, the inference system can be deployed as part of a “chat bot” or dialog system that responds to queries posed by users.

As another example, the text processing task can be text classification tasks, e.g., tasks that require classifying an input sequence of text into one of multiple categories. Examples of such tasks include entailment tasks, textual similarity tasks, sentiment tasks, grammaticality tasks, and so on.

As another example, the task can be a computer code generation task, where the input is a sequence of text describing the functionality of a piece of computer code, or a sequence of computer code to be modified or completed, or both and the output is a sequence of computed code that modifies the computer code, that has the functionality that is described by the sequence of text, or both.

As another example, the task can be a computer code understanding task, where the input is a sequence of computer code, and the output characterizes the sequence of computer code, e.g., summarizes the function of the code, describes review comments on the code, and so on.

As yet another example, the task can be an image processing task, e.g., a task that requires processing an input sequence that includes one or more tokens representing an image, e.g., generated by processing the image using a pre-trained encoder neural network. Examples of such tasks include image captioning, e.g., where the input represents an image and the output is a natural language text caption for the image, visual question-answering, where the input includes a text question about an image and tokens representing the image and the output includes a natural language answer to the image, and so on.

In some cases, the task can be a multi-modal task that requires processing, generating, or both tokens of multiple different modalities, e.g., two or more of text, images, video, audio, or other sensor data.

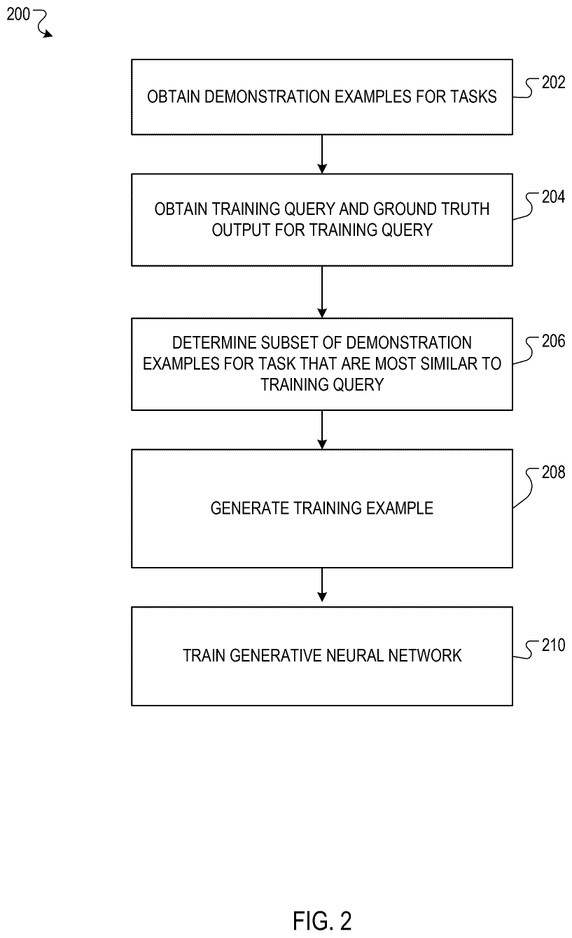

FIG. 2 is a flow diagram of an example process 200 for training a generative neural network. For convenience, the process 200 will be described as being performed by a system of one or more computers located in one or more locations. For example, a training system, e.g., the neural network training system 100 of FIG. 1, appropriately programmed in accordance with this specification, can perform the process 200.

The system obtains a respective set of demonstration examples for each of a plurality of tasks (step 202). As described above, each demonstration example includes a respective example query and a respective example output for the respective example query.

The system then repeatedly performs steps 204-208 to generate training examples for training the generative neural network. In particular, the system can perform multiple instances of the steps 204-208 multiple different times for each of the plurality of tasks to generate multiple different training examples for each of the tasks.

The system obtains a training query for the task and a ground truth output for the training query for the task (step 204). For example, the system can randomly select the training query and the ground truth output from the set of demonstration examples for the task. As another example, the system can maintain a separate set of candidate examples for each task, i.e., that is different from the set of demonstration examples for the task, and then select the training query randomly or otherwise from this separate set.

The system determines, from the respective set of demonstration examples for the task, a subset of demonstration examples that are most similar to the training query (step 206).

For example, the system can determine, as the subset, a fixed number of demonstration examples from the respective set of demonstration examples for the task that are most similar to the training query. The fixed number can be determined, e.g., from a user input or based on a size of the context window of the generative neural network being trained.

For example, the similarity can be a semantic similarity, so that the subset of demonstration examples are the examples that are most semantically similar to the training query.

The system can measure similarity between a demonstration example and a training query in any of a variety of ways.

For example, the system can measure similarity between a demonstration example and the training query as a similarity between the example query (and not the example output) in the demonstration example and the training query.

Thus, in this example, the system can select the subset by, for each demonstration example in the respective set, determining a respective measure of similarity between the example query in the demonstration example and the training query and then selecting, as the subset of demonstration examples that are most similar to the training query, a subset of demonstration examples that include example queries that are most similar to the training query according to the respective measures of similarity.

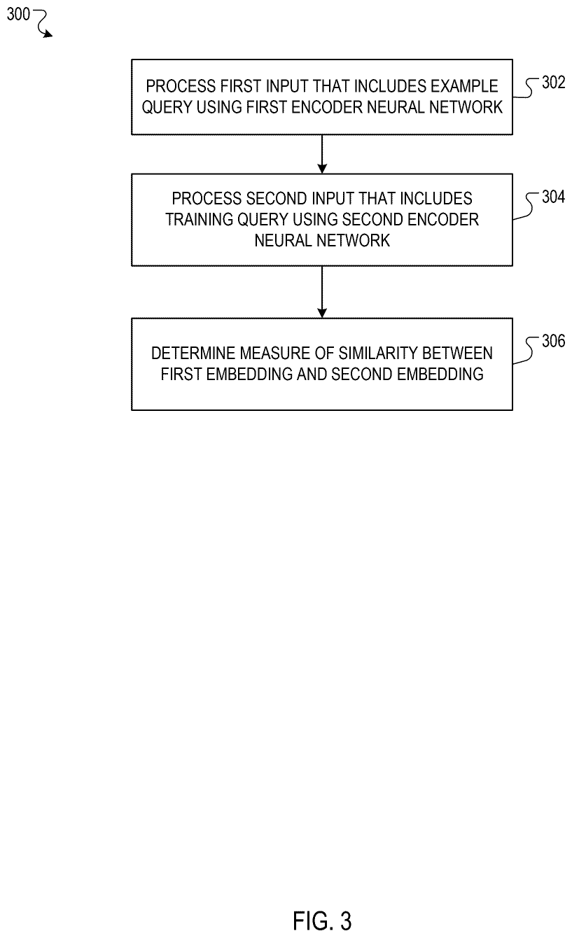

One example of determining a measure of similarity between an example query and a training query is described below with reference to FIG. 3.

As another example, the system can measure similarity between a demonstration example and the training query as a similarity between the entire demonstration example, i.e., both the example query and the example output in the demonstration example, and the training query.

Thus, in this example, the system can select the subset by, for each demonstration example in the respective set, determining a respective measure of similarity between the demonstration example, i.e., the entire example that includes both the example query and the example output in the demonstration example, and the training query and then selecting, as the subset of demonstration examples that are most similar to the training query, a subset of demonstration examples that are most similar to the training query according to the respective measures of similarity.

One example of determining a measure of similarity between a demonstration example and a training query is described below with reference to FIG. 3.

In either of the above techniques, the system can determine the measures of similarity and select the demonstration examples according to the respective measure of similarity by searching through the demonstration examples to identify k demonstration example, e.g., using a k-nearest neighbor search or an approximate k-nearest neighbor search, and then using the outputs of the search as the most similar demonstration examples.

The system generates a training example for the generative neural network (step 208). As described above, the training example includes (i) a training input that includes the training query and the subset of demonstration examples that are most similar to the training query and (ii) the ground truth output for the training query for the task.

The training input can also optionally include additional information. For example, the training input can include a task instruction for the task, e.g., a natural language instruction that describes the task, provides information about the format of outputs for the task, and so on.

Thus, as indicated above, rather than the training examples including no demonstration examples or randomly-selected demonstration examples, each training example includes the subset of demonstration examples that are most similar to the training query for the task.

The system trains the generative neural network on training data that includes the training examples for the plurality of tasks (step 210). For example, the system can train the generative neural network on an appropriate supervised fine-tuning objective. Examples of such objectives include cross-entropy objectives and negative log likelihood objectives.

FIG. 3 is a flow diagram of an example process 300 for determining a measure of similarity between an example query and a training query. For convenience, the process 300 will be described as being performed by a system of one or more computers located in one or more locations. For example, a training system, e.g., the neural network training system 100 of FIG. 1, appropriately programmed in accordance with this specification, can perform the process 300.

The system processes a first input that includes the example query in the demonstration example but does not include the example output in the demonstration example, using a first encoder neural network to generate a first embedding of the example query (step 302). The first input can also optionally include additional information. For example, the first input can include the task instruction for the task.

The system processes a second input that includes the training query using a second encoder neural network to generate a second embedding of the training query (step 304). The second input can also optionally include additional information. For example, the second input can include the task instruction for the task.

The first and second encoder neural network can generally be any appropriate neural network that has been trained to process a query, a demonstration example, or both to generate an embedding. In some cases, the first and second encoder neural network are the same neural network. In other cases, the first and second encoder neural networks are different neural networks.

For example, the first encoder, second encoder or both can be a self-attention neural network or a recurrent neural network that has been trained on a representation learning objective, e.g., through contrastive learning, or a self-supervised representation learning objective. As another example, when the demonstration examples, training queries, or both include multi-modal data, the first encoder, second encoder or both can be a multi-modal language model neural network or a visual language model neural network.

The system determines a measure of similarity between the first embedding and the second embedding (step 306). For example, the system can determine dot product or a Euclidean distance between the first embedding and the second embedding. The system then uses the measure of similarity as the measure of similarity as the example query and the training query.

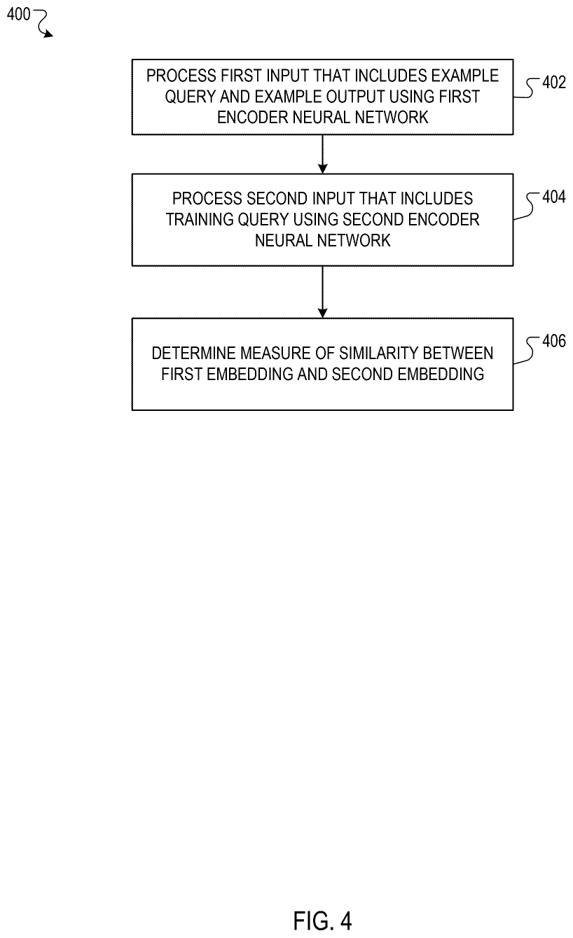

FIG. 4 is a flow diagram of an example process 400 for determining a measure of similarity between a demonstration example and a training query. For convenience, the process 400 will be described as being performed by a system of one or more computers located in one or more locations. For example, a training system, e.g., the neural network training system 100 of FIG. 1, appropriately programmed in accordance with this specification, can perform the process 400.

The system processes a first input that includes the example query in the demonstration example and the example output in the demonstration example using the first encoder neural network to generate a first embedding of the demonstration example (step 402). The first input can also optionally include additional information. For example, the first input can include the task instruction for the task.

The system processes a second input that includes the training query using the second encoder neural network to generate a second embedding of the training query (step 404). The second input can also optionally include additional information. For example, the second input can include the task instruction for the task.

The system determines a measure of similarity between the first embedding and the second embedding (step 406). For example, the system can determine dot product or a Euclidean distance between the first embedding and the second embedding. The system then uses the measure of similarity as the measure of similarity as the demonstration example and the training query.

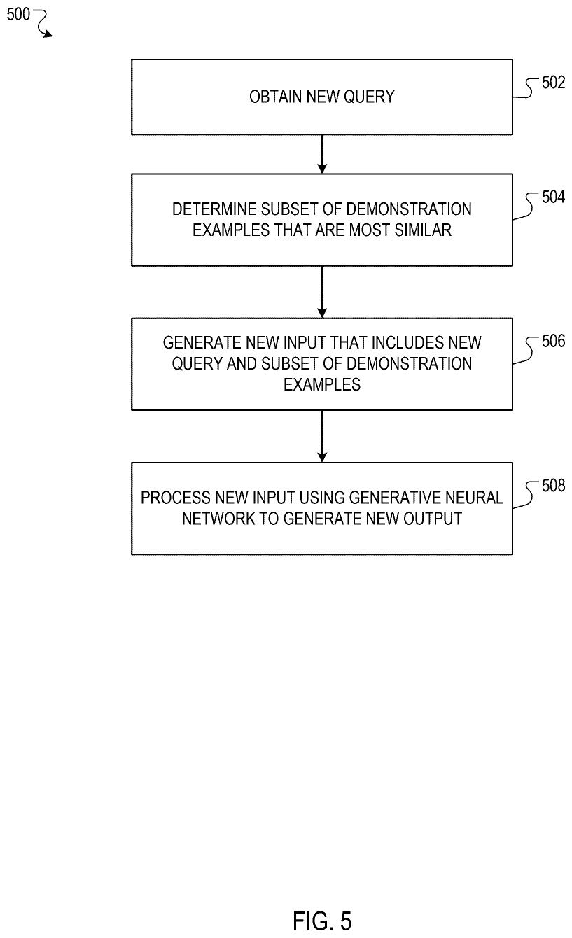

FIG. 5 is a flow diagram of an example process 500 for processing a new input after training. For convenience, the process 500 will be described as being performed by a system of one or more computers located in one or more locations. For example, an inference system, e.g., the neural network training system 100 of FIG. 1 or a different system of one or more computers, appropriately programmed in accordance with this specification, can perform the process 500.

After the above-described training, the system obtains a new query for a new task and set of demonstration examples for the new task (step 502). For example, the new task can be the same task as one of the ones used during training or can be a different task that is different from any of the tasks used during training.

The system determines, from the set of demonstration examples for the new task, a subset of demonstration examples that are most similar to the new query (step 504). The system can determine this similarity using any appropriate technique, e.g., using one of the techniques described above with reference to FIGS. 2-4, and using the same technique as or a different technique from the technique that was used during the training of the generative neural network.

The system generates a new input that includes the new query and the subset of demonstration examples that are most similar to the new query (step 506).

The system processes the new input using the generative neural network to generate a new output for the new query (step 508).

The system can then output the new output. For example, the new input can be received from a user device or from an external system and the system can provide the new output for presentation to a user of the user device or to the external system for further processing or storage.

As described above, because of the training techniques used to train the generative neural network, the generative neural network can effectively incorporate the demonstration examples to improve the quality of the new output, even if the new task is not one of the tasks that was used for the training of the generative neural network.

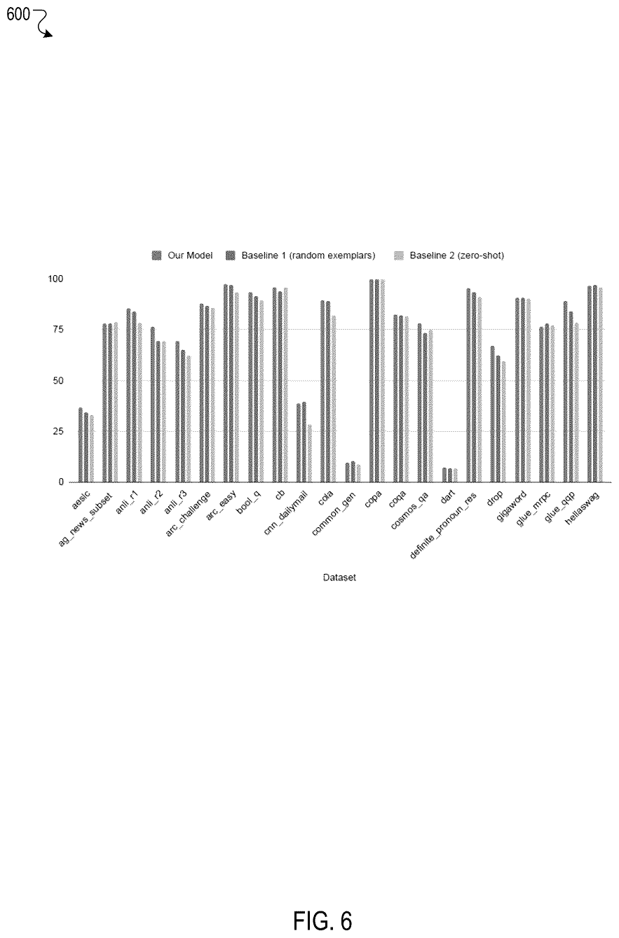

FIG. 6 shows an example 600 of the performance of the described techniques. In particular, the example 600 shows the performance of the described techniques (“our model”) relative to the same neural network trained using two baseline techniques-a “zero-shot” model optimized for zero-shot inference and a “Random ICL” model optimized with traditional supervised fine-tuning with randomly selected demonstration examples. In particular, the example 600 shows the performance of the techniques on a set of tasks after having been trained on a different set of tasks, i.e., so that the displayed tasks were not used during training. The results demonstrate that the described approach's intelligent exemplar selection leads to consistent performance gains. For example, on the “anli_r2” task, the described approach achieves a substantial +7% absolute improvement over the Random ICL baseline. Similar improvements are observed on other tasks, including a +4.5% gain on both the “anli_r3” and “cosmos_qa” tasks, a +4.57% gain on the “drop” task, and a +5% gain on the “glue_qqp” task.

These findings highlight the described approach's ability to effectively leverage informative in-context examples for improved performance on a diverse range of tasks, even when generalizing to unseen task types.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a generative neural network, the method comprising:
obtaining a respective set of demonstration examples for each of a plurality of tasks, wherein each demonstration example comprises a respective example query and a respective example output for the respective example query;
for each of the plurality of tasks:
obtaining a training query for the task and a ground truth output for the training query for the task;
determining, from the respective set of demonstration examples for the task, a subset of demonstration examples that are most similar to the training query;
generating a training example for the generative neural network, wherein the training example comprises (i) a training input that includes the training query and the subset of demonstration examples that are most similar to the training query and (ii) the ground truth output for the training query for the task; and
training the generative neural network on training data that includes the training examples for the plurality of tasks.

2. The method of claim 1, wherein prior to training the generative neural network on the training data, the generative neural network has been pre-trained on one or more pre-training data sets.

3. The method of claim 2, wherein the one or more pre-training data sets comprise one or more of an unsupervised data set or a supervised fine-tuning data set.

4. The method of claim 1, wherein the generative neural network is an auto-regressive neural network that is configured to process an input sequence to auto-regressively generate an output sequence for the input sequence.

5. The method of claim 1, wherein determining, from the respective set of demonstration examples for the task, a subset of demonstration examples that are most similar to the training query comprises:
determining a fixed number of demonstration examples from the respective set of demonstration examples for the task that are most similar to the training query.

6. The method of claim 1, wherein determining, from the respective set of demonstration examples for the task, a subset of demonstration examples that are most similar to the training query comprises:
determining, from the respective set of demonstration examples for the task, a subset of demonstration examples that are most semantically similar to the training query.

7. The method of claim 1, wherein determining, from the respective set of demonstration examples for the task, a subset of demonstration examples that are most similar to the training query comprises:
for each demonstration example in the respective set, determining a respective measure of similarity between the example query in the demonstration example and the training query; and
selecting, as the subset of demonstration examples that are most similar to the training query, a subset of demonstration examples that include example queries that are most similar to the training query according to the respective measures of similarity.

8. The method of claim 7, wherein determining a respective measure of similarity between the example query in the demonstration example and the training query comprises:
processing a first input that comprises the example query using a first encoder neural network to generate a first embedding of the example query;
processing a second input that comprises the training query using a second encoder neural network to generate a second embedding of the training query; and
determining a measure of similarity between the first embedding and the second embedding.

9. The method of claim 8, wherein the first encoder neural network and the second encoder neural network are the same neural network.

10. The method of claim 8, wherein the first encoder neural network and the second encoder neural network are different neural networks.

11. The method of claim 1, wherein determining, from the respective set of demonstration examples for the task, a subset of demonstration examples that are most similar to the training query comprises:
for each demonstration example in the respective set, determining a respective measure of similarity between the demonstration example and the training query; and
selecting, as the subset of demonstration examples that are most similar to the training query, a subset of demonstration examples that are most similar to the training query according to the respective measures of similarity.

12. The method of claim 11, wherein determining a respective measure of similarity between the demonstration example and the training query comprises:
processing a first input that comprises the example query in the demonstration example and the example output in the training example using a first encoder neural network to generate a first embedding of the demonstration example;
processing a second input that comprises the training query using a second encoder neural network to generate a second embedding of the training query; and
determining a measure of similarity between the first embedding and the second embedding.

13. The method of claim 12, wherein the first encoder neural network and the second encoder neural network are the same neural network.

14. The method of claim 12, wherein the first encoder neural network and the second encoder neural network are different neural networks.

15. The method of claim 1, further comprising, after the training:
obtaining a new query for a new task and set of demonstration examples for the new task;
determining, from the set of demonstration examples for the new task, a subset of demonstration examples that are most similar to the new query;
generating a new input that includes the new query and the subset of demonstration examples that are most similar to the new query; and
processing the new input using the generative neural network to generate a new output for the new query.

16. The method of claim 15, wherein the new task is different from any of the plurality of tasks.

17. The method of claim 15, further comprising:
outputting the new output in response to the new query.

18. The method of claim 17, wherein the new query is received from a user and wherein outputting the new output comprises providing the new output for presentation to the user on a user device.

19. The method of claim 1, wherein the training input further comprises a task instruction for the task.

20. A system comprising one or more computers and one or more storage devices storing instructions that when executed by the one or more computers cause the one more computers to perform operations for training a generative neural network, the operations comprising:
obtaining a respective set of demonstration examples for each of a plurality of tasks, wherein each demonstration example comprises a respective example query and a respective example output for the respective example query;
for each of the plurality of tasks:
obtaining a training query for the task and a ground truth output for the training query for the task;
determining, from the respective set of demonstration examples for the task, a subset of demonstration examples that are most similar to the training query;
generating a training example for the generative neural network, wherein the training example comprises (i) a training input that includes the training query and the subset of demonstration examples that are most similar to the training query and (ii) the ground truth output for the training query for the task; and
training the generative neural network on training data that includes the training examples for the plurality of tasks.

21. One or more non-transitory computer storage media storing instructions that when executed by one or more computers cause the one more computers to perform operations for training a generative neural network, the operations comprising:
obtaining a respective set of demonstration examples for each of a plurality of tasks, wherein each demonstration example comprises a respective example query and a respective example output for the respective example query;
for each of the plurality of tasks:
obtaining a training query for the task and a ground truth output for the training query for the task;
determining, from the respective set of demonstration examples for the task, a subset of demonstration examples that are most similar to the training query;
generating a training example for the generative neural network, wherein the training example comprises (i) a training input that includes the training query and the subset of demonstration examples that are most similar to the training query and (ii) the ground truth output for the training query for the task; and
training the generative neural network on training data that includes the training examples for the plurality of tasks.
